(19) United States
(12) Patent Application Publication
(10) Pub. No.: US 2023/0190026 A1
(43) Pub. Date: Jun. 22, 2023

(54) DRY ERASE TROPHY

(71) Applicant: Garven LLC, Edina, MN (US)

(72) Inventor: Lisa M. Bentley, Wayzata, MN (US)

(21) Appl. No.: 17/552,731

(22) Filed: Dec. 16, 2021

(51) Int. Cl. A47G 33/00; B43L 1/00

(52) U.S. Cl. CPC A47G 33/004; B43L 1/00

(57) ABSTRACT

A trophy includes a base and an award element on a top of the base. A dry erase element on the trophy is configured to be reusable with a dry erase marker for reusing the trophy. The dry erase element may be integrated into the trophy at the base or award element.

### FIELD

The present disclosure relates to trophies. More particularly, the present disclosure relates to a reusable trophy with a dry erase board for reuse of the trophy.

### BACKGROUND

The presentation of trophies and awards for achievements is common practice in many environments. However, such trophies may be expensive, especially when they are customized to a certain event, recipient, time period, or the like. It would be desirable to have a trophy that is reusable for different events.

### SUMMARY

In one embodiment, a trophy includes a base and an award element on a top of the base. A dry erase element on the trophy is configured to be reusable with a dry erase marker for reusing the trophy.

In another embodiment, a trophy includes a base, an award element on a top of the base, and a dry erase element integrated into the trophy, wherein writing on the dry erase element may be changed to reuse the trophy.

In yet another embodiment, a trophy kit includes a base, and an award element on a top of the base. A dry erase sheet having a pressure sensitive adhesive on one side and a dry erase surface on an opposite side is provided. The dry erase sheet is configured to be cut out to a desired dry erase element shape and affixed at a desired location on the trophy. A dry erase marker for marking the dry erase element to change a message on the affixed dry erase element for reuse of the trophy.

### BRIEF DESCRIPTION OF THE DRAWINGS

FIG. 1 is an isometric view of a trophy according to an embodiment of the present disclosure;

FIG. 2 is front elevation view of the trophy of FIG. 1;

FIG. 3 is an elevation view of the trophy of FIG. 2 rotated 45 degrees;

FIG. 4A is a front elevation view of a trophy according to another embodiment of the present disclosure;

FIG. 4B is a front elevation view of the trophy of FIG. 4A with dry erase/white board elements shown affixed thereto;

FIG. 5 is an isometric view of a trophy according to another embodiment of the present disclosure;

FIG. 6 is a front elevation view of a trophy according to another embodiment of the present disclosure;

FIG. 7 is a view of a dry erase marker used with embodiments of the present disclosure; and

FIG. 8 is a front elevation view of a trophy with a pre-printed message and a dry erase/white board element according to another embodiment of the present disclosure.

### DETAILED DESCRIPTION

Embodiments of the present disclosure provide a trophy with a reusable dry erase/white board element on which writing may be made, changed, erased, and reused.

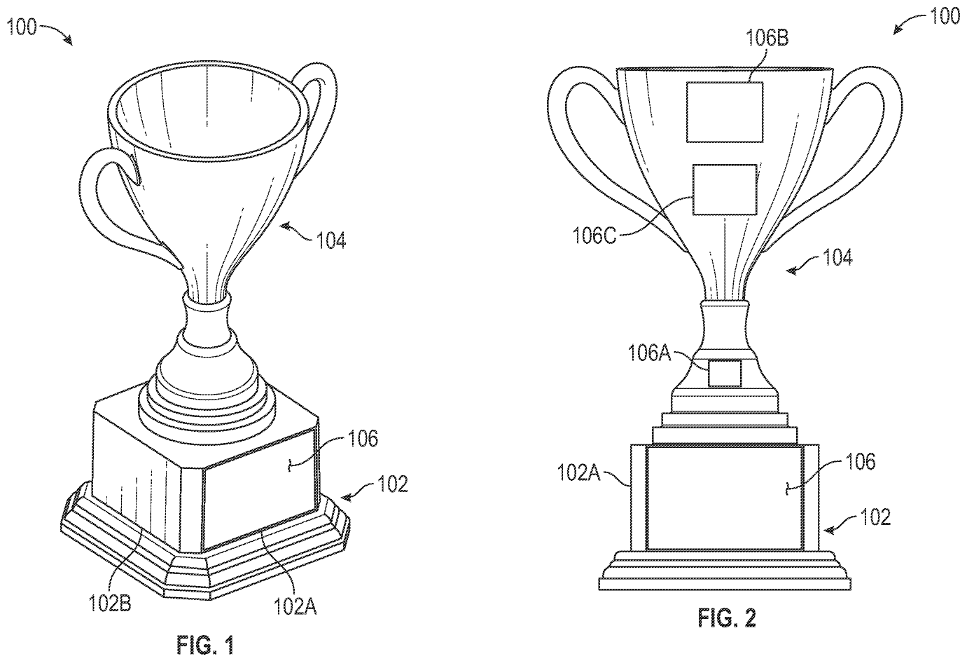

One embodiment of a trophy 100 is shown in isometric view in FIG. 1. Trophy 100 has a base 102 upon which a prize element/award element 104, such as but not limited to a cup, bust, wreath, or the like, is placed. A white board/dry erase element 106 is positioned either on the base 102 or on prize element 104. It should be understood that the white board/dry erase element 106 may be placed on one side of a multiple sided base 102, or on the prize element 104. In one embodiment, the white board/dry erase element 106 may comprise multiple dry erase elements 106 located or positioned at different spots on the base 102 and/or prize element 104. For example, a base 102 having four sides may have a white board/dry erase element 106 on more than one side.

In one embodiment, the white board/dry erase element is built into the base 102 and/or prize element 104. In another embodiment, the white board/dry erase element 106 is a dry erase board, white board or white board/dry erase element affixed to the base 102 and/or prize element 104, such as by being glued to the base 102 and/or prize element 104. In still another embodiment, a self-sticking white board/dry erase element 106 is provided with the trophy 100 so that an end user may affix the white board/dry erase element 106 to a location on the trophy of their choosing. In so doing, the user may place the white board/dry erase element 106 to the base 102, the prize element 104, including in numerous possible locations thereon.

When a trophy 100 is to be awarded to an individual, team, or the like, or a trophy is to be renamed, if an old writing is present on the white board/dry erase element 106, it may be removed by cleaning the white board/dry erase element 106. Then, using a dry erase marker or the like, a new recipient/trophy name may be written with the marker on the white board/dry erase element 106. In the event of multiple white board/dry erase elements 106, different inscriptions may be placed on different white board/dry erase elements 106. For example, a white board/dry erase element 106A may be positioned on a side of a base 102, and a white board/dry erase element 106B may be positioned on the prize element 104 above the white board/dry erase element 106A. In such a configuration, a year, competition, trophy name, recipient, or the like may be written on the white board/dry erase element 106B, and a different or same writing, such as a year, competition, trophy name, recipient, or the like may be written on white board/dry erase element 106A. Of course, the configuration of dry erase elements 106 may be switched, and any inscription may be placed on any of the white board/dry erase elements regardless of the descriptions provided herein, and without departing from the scope of the disclosure.

The base 102 need not be a square base, as described, but may be any shape. Further, it should be understood that the trophy 100 may comprise only a base 102, such as a monolith, cube, ball, or the like, in which the base 102 comprises an entirety of the trophy body. In such a configuration, a white board/dry erase element or elements 106 may be positioned at any point on the base 102, such as near a bottom, near a middle, at a top, or at multiple locations, with the location or locations being chosen by a user in the case of a fixed white board/dry erase element, or may be provided by a manufacturer in various configurations.

In the case in which a white board/dry erase element 106 is affixed to the trophy 100, a self-sticking white board/dry erase element may be provided with the trophy 100, and a user may then affect the white board/dry erase element 106 at a location or locations of their choice. In some configurations, multiple dry erase elements 106 are provided for affixing by the user to the base 102, prize element 104, or another part of the trophy 100.

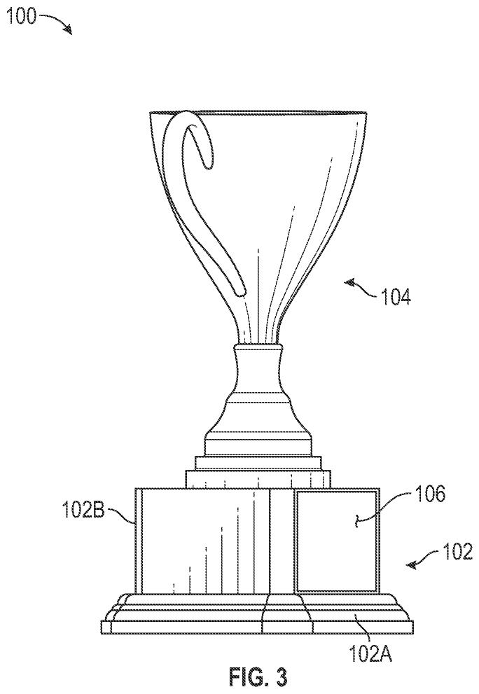

FIGS. 2 and 3 are, respectively, a front view and a view 45 degrees angled from the front view, of an embodiment of the trophy 100, showing the rectangular base 102, with the prize element 104 comprising a cup. A white board/dry erase element 106 is provided on a side 102A of the base 102. A white board/dry erase element 106 need not only be on a single side 102A of the base 102, but may be on multiple sides such as sides 102A and 102B, or a single white board/dry erase element 106 may extend around an entirety of the base 102. Further, a white board/dry erase element 106 may be placed on the prize element 104, such as at a base of the prize element 104, a middle of the prize element 104, or the lake, without departing from the scope of the disclosure. In FIG. 2, white board/dry erase elements 106A, 106B, and 106C are shown, respectively, on prize element 104 at a base, top, and middle thereof.

In the embodiment of FIGS. 1-3, trophy 100 comes prepared with a white board/dry erase element 106 or white board/dry erase elements 106 already positioned and affixed or integrated with the trophy 100 at a pre-chosen position(s) on the trophy 100.

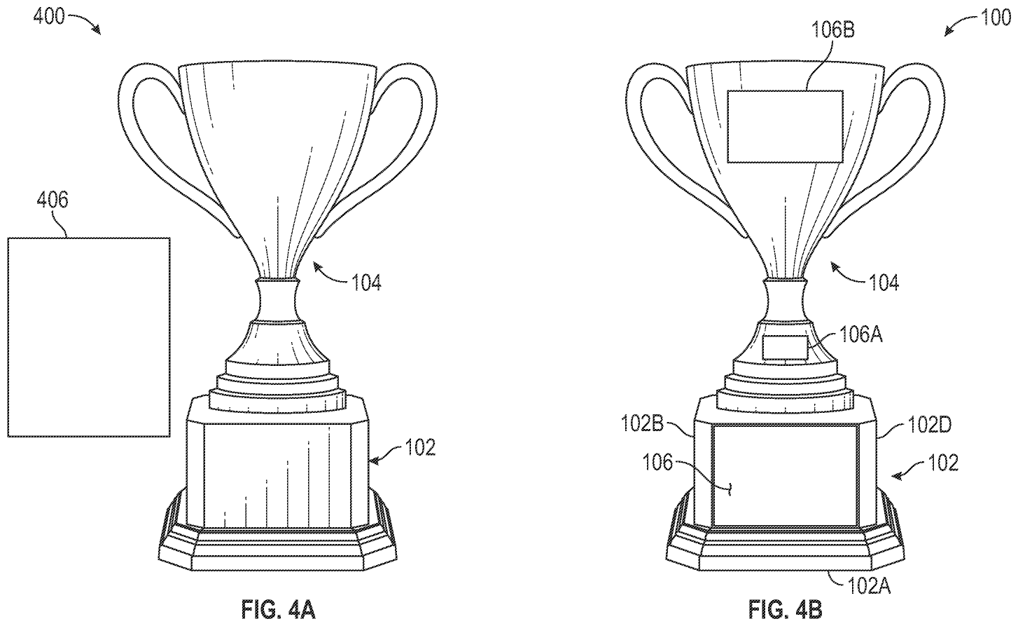

In another embodiment, as shown in FIG. 4, a blank trophy 400 is shown. The trophy 400 includes a base 102 and prize element 104, as in trophy 100. In this embodiment, the trophy is provided as a blank trophy, with a pressure sensitive adhesive white board/dry erase element 406 that may be cut or shaped to a specific size or shape for affixing to the trophy 400 by an end user. For example, a pre-adhesived sheet of white board/dry erase material 406 may be provided with side that is pre-glued and, once a user cuts or otherwise shapes the white board/dry erase element to a desired form, has a releasable sheet on a sticky back of the white board/dry erase element 106. When removed, this allows the user to affix the user-formed white board/dry erase element 106 to the trophy 100, such as on the base 102, the prize element 104, or at multiple locations. The shaped/formed white board/dry erase element 106 in such a configuration is limited only to the imagination of a user, and the size of the trophy 400, specifically its base 102 and/or prize element 104.

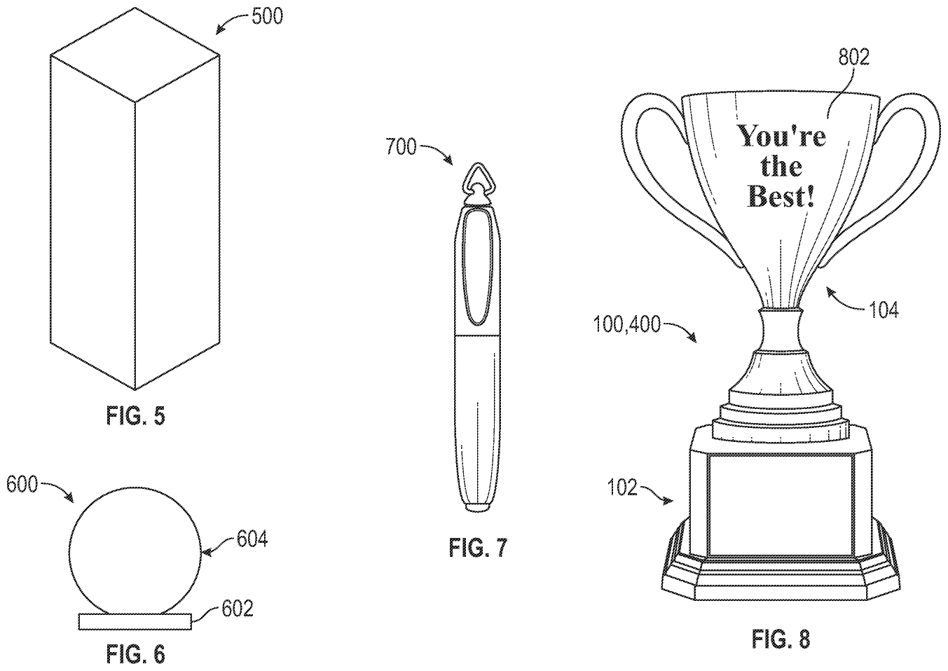

As has been mentioned, a trophy 100 need not have a base 102 and a prize element. In FIG. 5, a trophy 500 is shown which is simply a cuboid. In FIG. 6, a ball shaped trophy 600 comprises a sphere 604 on a small base 602. It should be understood that the shape configuration of trophies such as 100, 400, 600, and 600 is limited only to the desired shape and configuration. In a configuration in which white board/dry erase elements are fixable to the trophy 100, 400, 500, 600, a user may self-determine the shape and location of white board/dry erase element/elements. In preconfigured cases, white board/dry erase element/elements are already present on the trophy 100, 400, 500, 600.

In use, when a trophy such as trophy 100, 400, 500, 600 is to be awarded, a user uses a dry erase marker such as marker 700 shown in FIG. 7 to write on one or more white board/dry erase elements 106 that are positioned on the trophy 100, 400, 500, 600. Any message, recipient, or other notation may be made on the white board/dry erase elements 106 of the trophy 100, 400, 500, 600. A trophy, for example, may be a daily award in a classroom, for a specific event or time period, or the lake.

Pre-printed messages may be positioned on the trophy, such as one color black (1C black) printing of a specific message like message 802 shown in FIG. 8. However, no specific message need be provided, and the color of the printing may be one color, or multiple colors, and need not be black. The white board/dry erase element may be affixed to the trophy 100, 400, 500, 600 such as at a side of the base 102, or onto the prize element 104, with pressure sensitive adhesive.

In one embodiment, the trophies 100, 400, 500, 600 are made of a material such as Acrylonitrile Butadiene Styrene (ABS) plastic, and are covered with a metallic plating. For example, one metallic plating is a metallic gold UV plating. The base 102, 602 may comprise molded plastic and metallic plating. It should be understood that other materials may be used without departing from the scope of the disclosure.

While white board and dry erase elements are shown and discussed herein, and ABS plastic and metallic coatings are discussed and shown herein, it should be understood that different materials may be used for the composition of the trophies. Further, it should be understood that other forms of dry erase type elements may be used without departing form the scope of the disclosure. For example, a trophy may be made of ceramic, and provided with a spray-on coating that acts as a dry erase material. Any type of dry erase configuration, such as spray-on materials that act as dry erase materials, or the like, may be used with embodiments of the present disclosure, and are within the scope thereof. Such coatings may be sprayed on to or applied to any number of materials comprising the trophies, such as plastic, ceramic, and other materials.

Although the present disclosure has been described with reference to preferred embodiments, workers skilled in the art will recognize that changes may be made in form and detail without departing from the spirit and scope of the disclosure.

What is claimed is:

1. A trophy, comprising:
a base;
an award element on a top of the base; and
a dry erase element on the trophy, the dry erase element configured to be reusable with a dry erase marker for reusing the trophy.

2. The trophy of claim 1, wherein the dry erase element is a whiteboard.

3. The trophy of claim 1, wherein the dry erase element is integrated into the base.

4. The trophy of claim 1, wherein the dry erase element is integrated into the award element.

5. The trophy of claim 1, wherein the dry erase element is configured as a separate sheet configured to be cut out to a desired shape and affixed at a desired location on the trophy.

6. The trophy of claim 5, wherein the trophy has a plurality of possible dry erase element locations for use with the desired shape.

7. The trophy of claim 5, wherein the separate sheet comprises a dry erase surface and an opposite pressure sensitive adhesive surface.

8. A trophy, comprising:
a base;
an award element on a top of the base; and
a dry erase element integrated into the trophy, wherein writing on the dry erase element may be changed to reuse the trophy.

9. The trophy of claim 8, wherein the dry erase element is a whiteboard.

10. The trophy of claim 8, wherein the dry erase element is integrated into the base.

11. The trophy of claim 8, wherein the dry erase element is integrated into the award element.

12. A trophy kit, comprising:
a base;
an award element on a top of the base;
a dry erase sheet having a pressure sensitive adhesive on one side and a dry erase surface on an opposite side, the dry erase sheet configured to be cut out to a desired dry erase element shape and affixed at a desired location on the trophy; and
a dry erase marker for marking the dry erase element to change a message on the affixed dry erase element for reuse of the trophy.

13. The trophy kit of claim 12, wherein the dry erase element is a whiteboard.

14. The trophy kit of claim 12, wherein the dry erase element is integrated into the base.

15. The trophy kit of claim 12, wherein the dry erase element is integrated into the award element.

16. The trophy kit of claim 12, wherein the dry erase element is configured as a separate sheet configured to be cut out to a desired shape and affixed at a desired location on the trophy.

17. The trophy kit of claim 16, wherein the trophy has a plurality of possible dry erase element locations for se with the desired shape.

18. The trophy kit of claim 16, wherein the separate sheet comprises a dry erase surface and an opposite pressure sensitive adhesive surface.
